(19) United States
(12) Patent Application Publication
(10) Pub. No.: US 2007/0150909 A1
(43) Pub. Date: Jun. 28, 2007

(54) Disc drive

(76) Inventors: Takayuki Fujimoto, Tsuchiura (JP); Ikuo Nishida, Ebina (JP); Kohei Takita, Tokyo (JP); Yoichi Narui, Matsudo (JP); Masahiro Matsuo, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/528,511

(22) Filed: Sep. 28, 2006

(30) Foreign Application Priority Data
Dec. 22, 2005 (JP) 2005-369372

(51) Int. Cl. G11B 17/04; G11B 33/14

(52) U.S. Cl. 720/648; 720/602

(57) ABSTRACT

In a disc drive for achieving cooling of an electronic part therein, as well as, suppressing transmission of noises generated from a disc clamper, etc., a channel member 18 for introducing an outside air into an inside is disposed between a supporting member 15 and a top-cover 10, within an inside thereof is formed a vortex-like channel, extending from a center to an outer periphery thereof. At the center of the channel member 18 is formed an opening 19 for introducing the outside air into the inside of the disc drive, and on the top-cover 10 are provided plural numbers of openings 20 for taking the outside air into the channel member 18. When an optical disc 6 rotates, pressure generated on an upper surface thereof comes to be negative to the outside air, then the outside air is taken from the openings 20, through the vortex-like channel of the channel member 18 and the opening 19, into the inside of the drive, so as to pass through electronic parts, such as, an optical pickup, etc., thereby cooling them. Noises generated from the disc clamper 17 are attenuated within the vortex-like channel of a long route, which is formed within the channel member 18.

### BACKGROUND OF THE INVENTION

The present invention relates to a storage device and an electronic device mounting a storage device therein, and in particular, it relates to a storage device having therein structures of rotationally driving an orbicular disc.

A recording apparatus of disc rotation drive method (i.e., the disc drive) is an apparatus for recording (or writing) data onto a surface of the disc, as well as, for reproducing (or reading) the data recorded on the surface of the disc, under the condition of rotating the orbicular disc, as being data recording media.

Within such the disc drive is mounted an electronic part, which includes a laser light source and a laser light receiving portion, etc., as signal writing and reading means for recording and reproducing the data.

In case when this disc drive is an optical disc drive, for example, in general, such the electronic part as was mentioned above is called by “optical pickup” or only “pickup”.

Also, in case when this disc drive is a magnetic disc drive, for example, then that electronic part mentioned above, in general, it is called by “header”, in the place thereof.

As such the discs, in the case of the optical disc drive, the followings can be listed up as the data recording media: i.e., CD-ROM, CD-R, CD-RW, DVD-ROM, DVD-R, DVD-RW, DVD-RAM, DVD+R, and DVD+RW, etc., for example.

In general, such the disc drive is installed within an electronic apparatus (such as, a personal computer, etc.), which includes therein a central processing unit (i.e., CPU) for conducting access control to the disc drive and calculation operation, etc. In the following, an outline will be shown of the optical disc drive, as one of the representative structures of the conventional disc drive.

Within a box-like housing are provided a spindle motor for rotationally driving the optical disc and an optical pickup for recording and reproducing data. In a lower portion of the box-like housing is positioned a printed circuit board (PCB), and a top-cover, a bottom-cover and a front panel surround or enclose therein the optical disc drive as a whole, thereby building up the box-like housing.

Herein, a large number of heat-generating elements are mounted on the printed circuit board. And, a heat-conductive member having a high thermal conductivity is stuck on each of principal heat-generating elements, wherein the heat generated from the heat-generating element is transferred to the bottom-cover through that heat-conductive member, to be radiated into an outside air from the bottom-cover.

Further, within an inside of the housing of the optical disc drive, there is provided a rotor for fastening the optical disc onto a turntable on the spindle motor. The turntable is a member of being disc-like in the shape thereof, and it has built-in permanent magnets for fastening the rotor. When driving such the drive, the optical disc is put between the turntable and the rotor, and under such the condition the optical disc is rotated through rotationally driving the spindle motor at high speed.

In present, such the disc drives are in tendency of becoming large in the memory capacity and high in the speed thereof. For that reason, density of heat-generation within the drive is further increased, and as a result thereof, a drawback comes to be remarkable; i.e., the electronic parts, such as the pickup, etc., comes up to be high in temperature thereof, and thereby lowering the performances of the drive.

For dissolving such the drawback, a technology of providing an opening on the top-cover, at the position opposing to the means for rotationally driving the disc, for example, in the following Patent Documents 1 and 2. Thus, this technology adopts therein a method of cooling an inside of the drive by taking the outside air from that opening portion, with using the fact that a negative pressure is generated on the upper surface of the disc due to the disc rotation.

[Patent Document 1] Japanese Patent Laying-Open No. 2004-241024 (2004); and

[Patent Document 2] Japanese Patent Laying-Open No. 2003-249070 (2003).

With such the structures, as was shown in the Patent Document 1 or 1, i.e., providing the opening portion on the top-cover at the position opposing to the means for rotationally driving the disc, thereby taking the outside air from that into the inside of the disc drive; however, although it is possible to achieve the cooling within the inside of the drive, but there is also a drawback that noises generated from a disc clamper comes to be large in the level thereof, when driving such the drive.

### BRIEF SUMMARY OF THE INVENTION

An object is, according to the present invention, to provide a disc drive enabling to cool the electronic parts while suppressing transmission of the noises, which is generated from the disc clamper, etc., into an outside of the drive.

A disc drive, according to the present invention, comprises: a housing, being formed with an opening for sucking an outside air on an upper surface thereof and an opening for discharging air on a side surface thereof; a disc drive means, being disposed within an inside of said housing, for supporting a central portion of the disc-like data recording medium, so as to drive it, rotationally; and a noise generation attenuating member.

And, the noise generation attenuating member is disposed between the upper surface of said housing and said disc drive means, and has an attenuation channel communicating with said opening for sucking an outside air, extending along said upper surface, and formed with an opening on an inner side of said housing.

With the attenuation channel mentioned above, the noises generated from the disc drive means are attenuated during when they propagated into an outside of the disc drive.

The opening formed on an inner side of the housing of the attenuation channel is formed at a position corresponding to a center of rotation of said disc drive means, and the attenuation channel may be formed into a vortex-like shape, or a radial shape in plural numbers thereof.

Also, the noise generation attenuating member has a bottom surface positioned on the side of said disc drive means and a side surface formed on a periphery of the bottom surface, surrounding a surface including the opening formed on said upper surface, and the opening formed on the inner side of said housing is formed on said side surface.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a perspective view for showing the structures, briefly, of an inside of an optical disc drive, into which a first embodiment of the present invention is applied;

FIG. 2 is a horizontal cross-section view for showing the structures, briefly, of the inside of the optical disc drive, into which the first embodiment of the present invention is applied;

FIG. 3 is a view for showing the structures of flow passages for introducing an outside air, in the optical disc drive, into which the first embodiment of the present invention is applied;

FIG. 4 is a view for showing a manner of airflow within the inside of the optical disc drive, into which the first embodiment of the present invention is applied, in particular, when it is driven;

FIG. 5 is a view for showing the structures of flow passages for introducing the outside air, according to a second embodiment of the present invention;

FIG. 6 is a view for showing the structures of flow passages for introducing the outside air, according to a third embodiment of the present invention;

FIG. 7 is a perspective view for showing the structures, briefly, of an inside of the optical disc drive, into which a fourth embodiment of the present invention is applied; and

FIG. 8 is a view for showing the brief inside structures and airflows within an inside, of the optical disc drive, into which the fourth embodiment of the present invention is applied.

### DETAILED DESCRIPTION OF THE INVENTION

Hereinafter, embodiments according to the present invention will be fully explained by referring to the attached drawings. However, the embodiment shown below is a case where the present invention is applied into an optical disc drive.

### First Embodiment

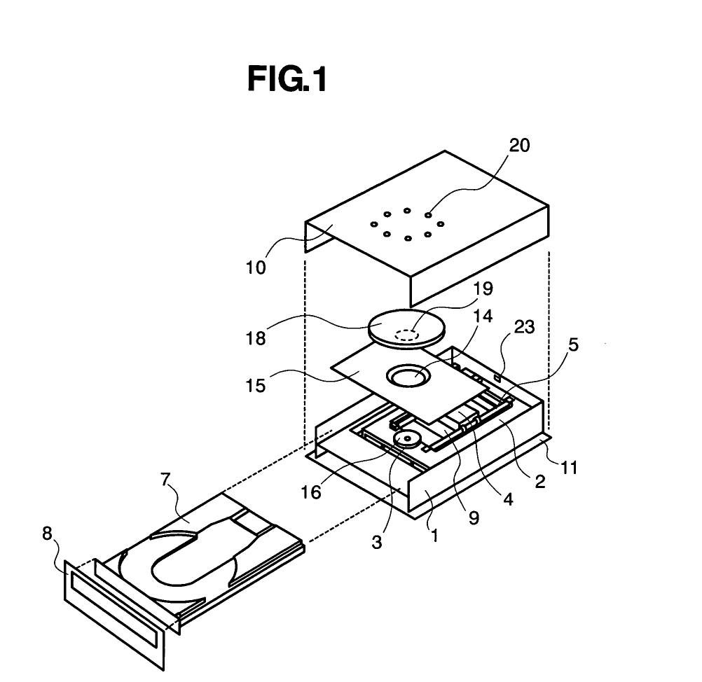

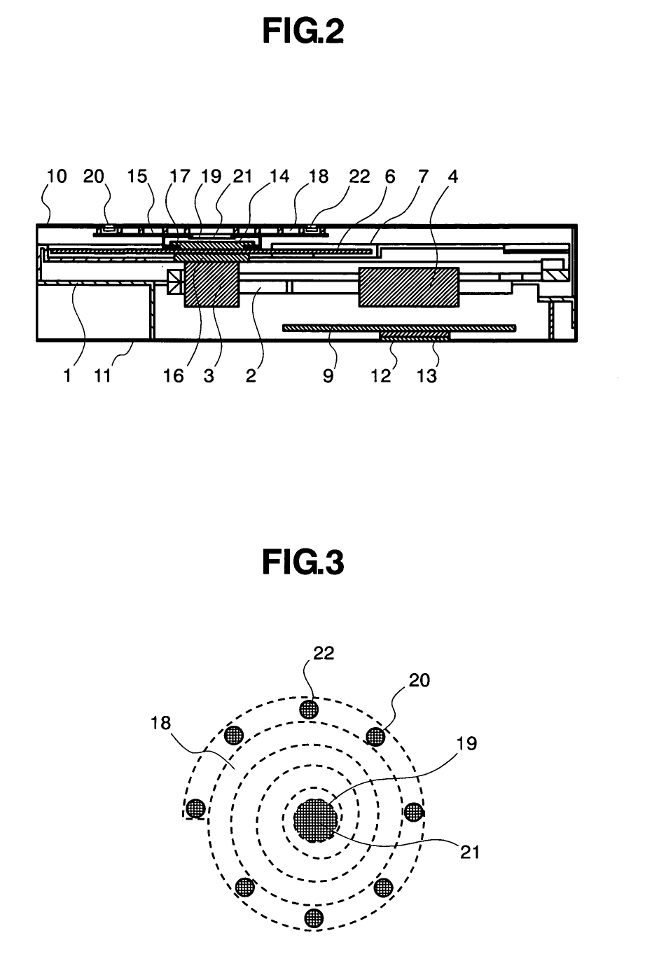

FIG. 1 is a perspective view for showing the structures, briefly, of an inside of an optical disc drive, into which a first embodiment of the present invention is applied. And, FIG. 2 is a horizontal cross-section view for showing the structures, briefly, of the inside of the optical disc drive, into which the first embodiment of the present invention is applied.

Further, FIG. 3 is a view for explaining flow passages (or channels), which are provided within a space defined between a member for supporting a rotor for fastening an optical disc and a top-cover, within the optical disc drive, into which the first embodiment of the present invention is applied, being seen from a side of the top-cover.

In FIGS. 1 through 3, a mechanical chassis 2 is mounted within a mechanical base 1, which is received within a box-like housing. The mechanical chassis 2 comprises a spindle motor 3 for rotationally driving an orbicular optical disc 6, an optical pickup 4 for writing data onto a disc surface of the optical disc 6, or for reading the data written on the disc surface thereof, and a transfer means (not shown in the figure) for transferring the optical pickup 4 along two (2) pieces of rod-like guide bars.

A disc tray 7, for storing the optical disc 6 into an inside of the optical disc drive and for taking out the optical disc 6 from the disc drive, is moved on a guide provided on the mechanical base 1, by means of a motor (not shown in the figure).

In a lower portion of the mechanical base 1 is positioned a printed circuit board 9, and a top-cover 10, a bottom cover 11 and a front panel 8 are surrounding the mechanical base 1, as a whole, thereby defining a box-like housing.

The printed circuit board 9 is located nearly in parallel to the bottom-cover 11, and further is fixed, defining a gap of predetermined size from it. On a main or principle heat-generating element 12 is stuck or adhered a heat-conductive member 13 having a high thermal conductivity, and therefore the heat generating from the heat-generating element 12 it transferred to the bottom-cover 11 through the heat-conductive member 13.

A rotor 14 for fastening or fixing the optical disc 6 onto a turntable 16 on the spindle motor 3 is supported by a plate-like supporting member 15, which is supported to be nearly in parallel to a rotating surface of the optical disc 6. A central portion of the supporting member 15 is removed to define an opening, and the rotor 14 is mounded into the opening portion, while both end portions of the supporting member 15 are fixed on a side wall of the mechanical base 1.

The turntable 16 is a member of being disc-like in the shape thereof, and it has built-in permanent magnets therein, for fastening the rotor 14 thereon. When the disc drive is driven, the optical disc 6 is put between the turntable 16 and the rotor 14, and under this condition, the optical disc 6 is driven to rotate through driving the spindle motor 3 at high speed.

In this manner, the turntable 16, the spindle motor 3 for rotationally driving the turntable 16, and the rotor 14 for magnetically fastening the optical disc 6 on the turntable 16 build up a means for rotationally driving the disc.

However, herein, the rotor 14 and the supporting member 15 for supporting the rotor 14 are called, collectively, by a name of a disc clamper 17.

Within a space defined between the supporting member 15 and the top-cover 10 is disposed a channel (or flow-passage) member (i.e., a sound generation attenuating member) 18, for guiding or introducing an outside air into an inside of the disc drive. The channel member 18 is shown by an outlook configuration thereof, briefly, in FIG. 1, but within an inside of the channel member 18 is formed a vortex-like flow passage or channel, directing from a central portion up to an outer peripheral portion thereof, as shown in FIGS. 2 and 3.

The central portion of the channel member 18 is opposing to the rotor 14, and at this central portion is provided an opening 19 for guiding or introducing the outside air into the inside of the disc drive. And, at the opening 19 is attached a filter 21 for preventing foreign matters, such as, dusts or like supplied from the outside of the drive, from mixing and entering into the inside of the disc drive.

Further, openings 20 are provided on the top-cover 10, for taking the outside air into the channel member 18, in plural numbers thereof. Those plural numbers of openings 20 are arranged at positions corresponding to an outer periphery of the channel of the vortex-like flow passage within the channel member 18. And, each of those openings 20 is provided with a filter 22 for preventing foreign matters, such as, dusts or the like from the outside of the drive, from mixing and entering into the inside of the disc drive.

Herein, the shape of the opening may be circular or rectangular. Further, FIG. 3 is an explanatory view, when seeing the channel member 18 from a side of the top-cover 10, wherein the channel wall and the opening 19 at the center of channel are indicated by broken lines, although they cannot seen, actually, thereon.

On a rear surface of the mechanical base 1 is provided an opening 23 for discharging the outside air, which is taken in through the vortex-like channel formed within the channel member 18, together with a filter for preventing the foreign matters from mixing and entering into the inside of the disc drive. This opening 23 for discharging may be circular or rectangular in the shape thereof.

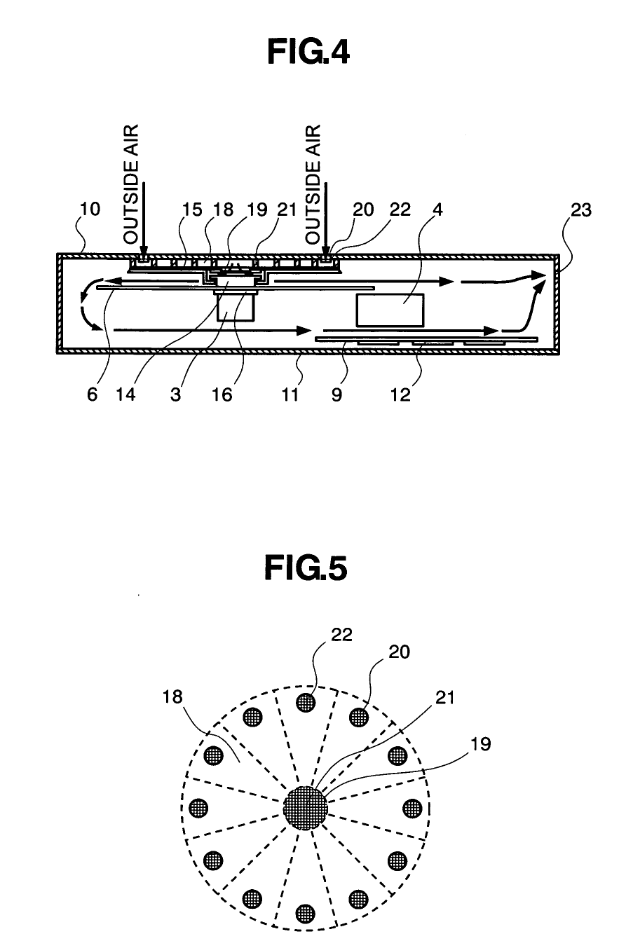

FIG. 4 is a view for showing a manner of airflow within the inside of the optical disc drive, into which the first embodiment of the present invention is applied, in particular, when it is driven.

In this FIG. 4, when the optical disc 6 is rotated, the outside air is taken into an inside of the disc drive, from the openings 20 of the top-cover 10 through the vortex like-channel of the channel member 18 and further the opening 19, because a negative pressure to the outside air is generated on an upper surface of the disc 6. And, the outside air taken into passes through electronic parts, such as the optical pickup 4, as being a means for reading, etc., thereby cooling them, effectively.

Further, when the outside air is taken into the inside of the disc drive from the opening 20 of the top-cover 10 through the channel member 18, the noises generated by the disc clamper 17 is attenuated within the vortex like-channel having a long route, which is formed within the channel member 18; therefore, it is possible to lower or reduce a level of the noises generated when driving the disc drive. Also, provision of noise absorption material within the channel member 18 enables to reduce down the noise level, further.

Therefore, according to the first embodiment of the present invention, it is possible to reduce the noise level, as well as, lowering the temperature within the inside of the disc drive and also the electronic parts therein, in particular, when driving it, thereby achieving a large memory capacity and a high speed of the drive.

### Second Embodiment

Next, explanation will be made on a second embodiment according to the present invention, by referring to FIGS. 1 and 5.

FIG. 5 is an explanatory view for showing a view seeing from the side of the top-cover 10, in particular, of the channel member, which is provided within the space defined between the supporting member 15 and the top-cover 10, within the optical disc drive, into which the second embodiment of the present invention is applied.

Although the flow passage or channel formed within the channel member 18 is vortex-like, directing from the center of the channel to the outer peripheral portion thereof, in the structures thereof, as shown in FIG. 3, according to the first embodiment; however, the flow passage or channel formed within the channel member 18, according to the second embodiment, is in radiation-like, directing form the center of channel to the outer periphery thereof, and the shape of the channel wall thereof is a straight line.

At a portion opposing to the rotor 14, i.e., at the center of the channel member 18, there is provided the opening 10 for guiding or introducing the outside air into the inside of the disc drive. And, at this opening 19 is also provided the filter 21 for preventing foreign matters, such as, dusts or like supplied from the outside of the drive, from mixing and entering into the inside of the disc drive.

Further, at portions on the top-cover 10, corresponding to the position of outer periphery of the channel member 18, there are provided openings 20, for taking the outside air into the channel member 18. And, each of those openings 20 is provided with the filter 22 for preventing foreign matters, such as, dusts or the like from the outside of the drive, from mixing and entering into the inside of the disc drive

Herein, the shape of the opening may be circular or rectangular. Further, FIG. 5 is an explanatory view, when seeing the channel member 18 from a side of the top-cover 10, wherein the channel wall and the opening 19 at the center of channel are indicated by broken lines, although they cannot seen, actually, thereon. Also, a noise absorbing material may be provided within the channel member 18.

With such the second embodiment according to the present invention, as was mentioned above, it is possible to obtain an effect similar to that with the first embodiment.

### Third Embodiment

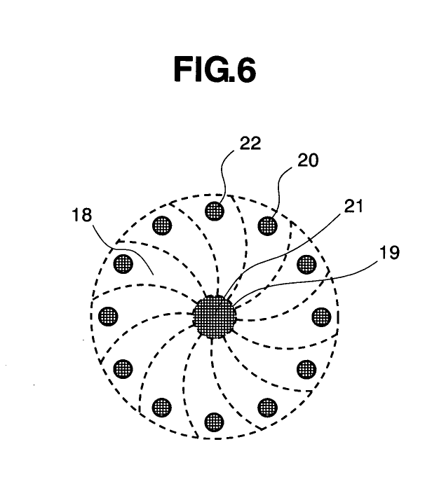

Next, explanation will be made on a third embodiment according to the present invention, by referring to FIGS. 1 and 6.

FIG. 6 is an explanatory view for showing a view seeing from the side of the top-cover 10, in particular, of the channel member, which is provided within the space defined between the supporting member 15 and the top-cover 10, within the optical disc drive, into which the third embodiment of the present invention is applied.

Although the flow passage or channel formed within the channel member 18 is vortex-like, directing from the center of the channel to the outer peripheral portion thereof, in the structures thereof, as shown in FIG. 3, according to the first embodiment; however, the flow passage or channel formed within the channel member 18, according to the third embodiment, is in radiation-like, directing form the center of channel to the outer periphery thereof, but the shape of the channel wall thereof is a curved line.

Other structures of the mentioned above are similar to those of the second embodiment shown in FIG. 5, therefore explanation of them will be omitted herein.

With such the third embodiment according to the present invention, as was mentioned above, it is possible to obtain an effect similar to that with the first embodiment.

### Fourth Embodiment

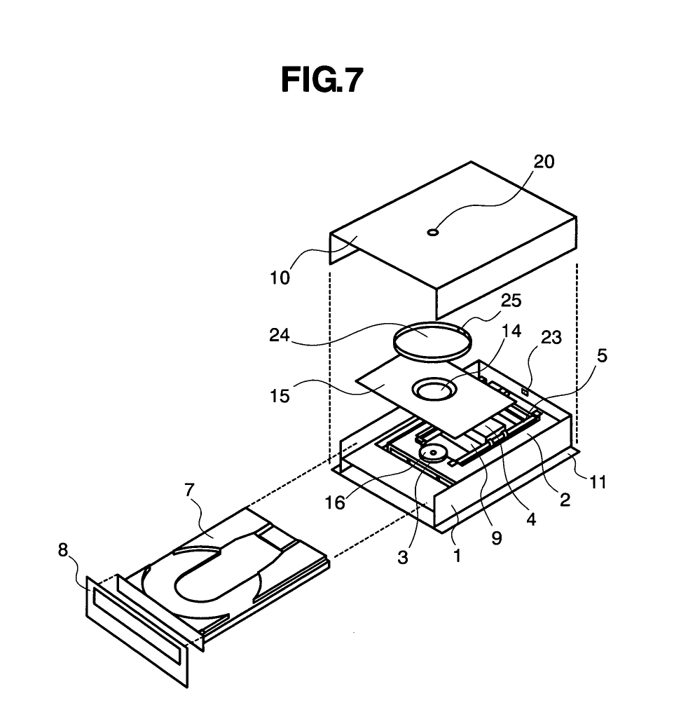

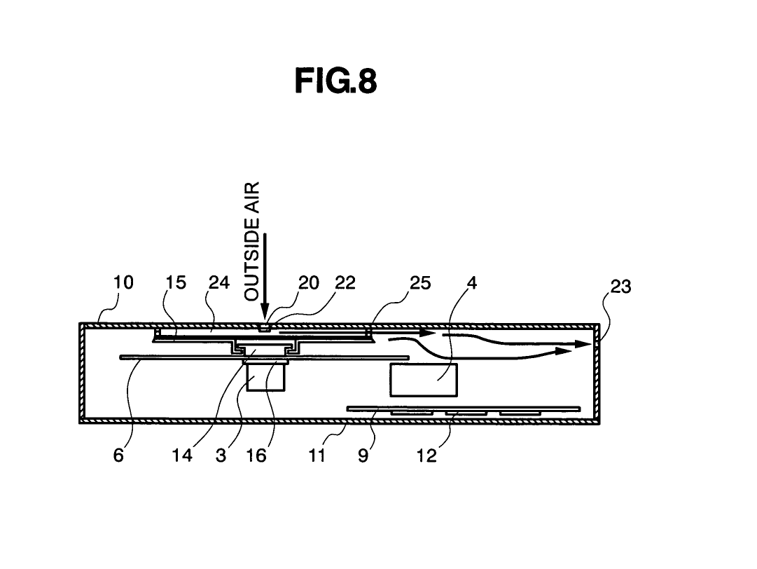

Next, explanation will be made on a fourth embodiment according to the present invention, by referring to FIGS. 7 and 8 attached herewith.

FIG. 7 is a perspective view for showing the structures, briefly, of an inside of the optical disc drive, into which a fourth embodiment of the present invention is applied, and FIG. 8 is a view for showing the brief inside structures and airflows within an inside, of the optical disc drive, into which the fourth embodiment of the present invention is applied.

The difference between the fourth embodiment and the first embodiment lies in the position where the openings are formed on the top-cover 10, and the number thereof, and according to the fourth embodiment, a guidance member (noise generation attenuating member) 24 is disposed in the place of the channel member 18, according to the first embodiment.

Other structures of the mentioned above are similar to those of the second embodiment shown in FIG. 5, therefore explanation of them will be omitted herein.

In FIGS. 7 and 8, between the top-cover 10 and the supporting member 15 is disposed the guidance member 24, for taking the outside air into the inside of the disc drive. On the top-cover 10 opposing to the portion where the guidance member 24 is provided, there is formed the openings 20 for taking the outside air into the guidance member 24, at the position corresponding to the center of thereof. And, on the opening 20 is attached the filter 22 for preventing foreign matters, such as, dusts or the like from the outside of the drive, from mixing and entering into the inside of the disc drive.

Also, on a side surface of the guidance member 24 is/are formed a single (or one (1) piece) of plural pieces of opening(s) 25. However, no opening is formed at the portion opposing to the rotor 14 at the center of a bottom surface within the guidance member 24. And, in this guidance member 24 no such flow passage or channel is formed, as was in the first to third embodiments, i.e., the guidance member 24 is opened on an upper portion thereof, but it is covered with the top-cover 10 on the upper portion thereof. In this case, it is also possible to provide a noise-absorbing member within the guidance member 24.

Because of the negative pressure to that of the outside air generated upon an upper surface of the optical disc 6, due to the rotation thereof, the outside air taken into the guidance member 24 from the openings 20, passing through the opening 25, is guided or introduced into the inside of the disc drive.

The air introduced from the outside into the inside of the disc drive, after cooling down the optical pickup 4, is discharged from the opening 23 into the outside of the disc drive. However, the shape of the openings 20 and 25 may be circular or rectangular.

Within the fourth embodiment mentioned above, the noises generated from the disc clamper 17 is attenuated within an inner space in the guidance member 24, when the outside air is taken into the inside of the disc drive from the openings 20 on the top-cover 10 and the inner space of the guidance member 24 through the opening 25; therefore, it is possible to reduce the level of noises generating when driving the disc drive. Also, providing the noise-absorbing member within the guidance member 24 further enables to lower down the noise level, much more.

Therefore, it is possible to reduce the noise level, as well as, lowering the temperature within the inside of the disc drive and also the electronic parts therein, in particular, when driving it, thereby achieving a large memory capacity and a high speed of the drive.

Although the explanation was given that the position where the printed circuit board 9 is located is in the lower portion of the mechanical base 1, in the first, second, third and fourth embodiments, according to the present invention, however the printed circuit board 9 may be disposed in an upper portion (or above) of the mechanical base 1, i.e., on a side of the top-cover 10. Also, the position and/or the number of the openings 20 and 25 formed on the top-cover 10 should not be limited only to that shown in the above.

Further, the disc drive, into which the present invention is applied, should not be limited only to the optical disc drive, and it may be a magnetic disc drive, in the place thereof.

Also, the channel member 18 and the guidance member 24 may be made of a metal or a resin, etc.

Moreover, electronic apparatuses, which mounts the disc drive applying the present invention therein, may includes, not only the personal computer, but also includes an on-vehicle computer, such as, a hard-disc recorder, a car navigation system, etc., or a game computer or the like, for example.

As was mentioned above, according to the present invention, it is possible to provide a disc drive enabling to cool the electronic parts while suppressing transmission of the noises, which is generated from the disc clamper, etc., into an outside of the drive.

Thus, with the disc drive according to the present invention, since the noises level can be reduced when driving the disc drive, as well as, cooling the electronic part, such as, the pickup, as being the signal writing and/or reading means, therefore it is possible to achieve a large memory capacity and a high speed of the drive.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A disc drive, for driving a disc-like data recording medium, comprising:
a housing, being formed with an opening for sucking an outside air on an upper surface thereof and an opening for discharging air on a side surface thereof;
a disc drive means, being disposed within an inside of said housing, for supporting a central portion of the disc-like data recording medium, so as to drive it, rotationally; and
a noise generation attenuating member, being disposed between the upper surface of said housing and said disc drive means, having an attenuation channel communicating with said opening for sucking an outside air, extending along said upper surface, and formed with an opening on an inner side of said housing.

2. The disc drive as described in the claim 1, wherein on the opening for sucking the outside air formed on the upper surface is attached a filter for preventing foreign matters from mixing therein.

3. The disc drive as described in the claim 2, wherein on the opening of said noise generation attenuating member, which is formed on a side of said disc drive means, is attached a filter for preventing foreign matters from mixing therein.

4. The disc drive as described in the claim 3, wherein the attenuation channel of said noise generation attenuating member is formed into a vortex-like shape, the opening formed on the inner side of said housing is located at a position corresponding to a center of rotation of said disc drive means, and the openings on the upper surface for sucking the outside air are formed in plural numbers thereof, along an outer peripheral flow passage of said vortex-like attenuation channel.

5. The disc drive as described in the claim 3, wherein said noise generation attenuating member has a circular shape, the opening formed on the inner side of said housing is located at a position corresponding to a center of rotation of said disc drive means, said attenuation channels are formed in plural numbers thereof, extending in radial directions from the opening on the side of said disc drive means, and the openings on the upper surface for sucking the outside air are formed in vicinity of outer ends of the plural numbers of attenuation channels in said circular-shaped noise generation attenuating member, respectively.

6. The disc drive as described in the claim 5, wherein the attenuation channels extending in radial directions are formed along curved lines.

7. The disc drive as described in the claim 3, wherein the opening for sucking the outside air formed on the upper surface is located at a position corresponding to a center of rotation of said disc drive means, said noise generation attenuating member has a bottom surface positioned on the side of said disc drive means and a side surface formed on a periphery of the bottom surface, surrounding a surface including the opening formed on said upper surface, and the opening formed on the inner side of said housing is formed on said side surface.
